(19) United States
(12) Patent Application Publication
(10) Pub. No.: US 2017/0344244 A1
(43) Pub. Date: Nov. 30, 2017

(54) DISPLAY DEVICE AND COMPUTER-READABLE NON-TRANSITORY RECORDING MEDIUM RECORDING DISPLAY CONTROL PROGRAM

(71) Applicant: KYOCERA Document Solutions Inc., Osaka (JP)

(72) Inventors: Shoichi SAKAGUCHI, Osaka (JP); Tetsuya NISHINO, Osaka (JP)

(73) Assignee: KYOCERA Document Solutions Inc., Osaka (JP)

(21) Appl. No.: 15/592,422

(22) Filed: May 11, 2017

(30) Foreign Application Priority Data
May 26, 2016 (JP) 2016-105528

(51) Int. Cl. G06F 3/0485; G06F 3/0488; G09G 5/34

(52) U.S. Cl. CPC G06F 3/04855; G09G 5/34; G06F 3/04886; G09G 2354/00

(57) ABSTRACT

A display device includes a display section having a touch panel function, and a control unit that includes a processor and performs, as a result of operation performed in accordance with an operation program by the processor, display control of the display section and control of receiving an instruction based on touch operation performed on the display section and detected by the touch panel function. The control unit performs, upon reception of an instruction for scrolling based on the touch operation, scroll display of a display screen, and calculates a display end position of a display target image provided by the scroll display based on the instruction for scrolling, and before ending of the scroll display, displays, at a predefined position in a display region of the display section, at least one portion of a final image to be displayed at the display end position.

### INCORPORATION BY REFERENCE

This application claims priority to Japanese Patent Application No. 2016-105528 filed on 26 May 2016, the entire contents of which are incorporated by reference herein.

### BACKGROUND

This disclosure relates to a display device and a computer-readable non-transitory recording medium recording a display control program, and more specifically to a technology of scroll-displaying an image displayed at a display section.

Mobile devices such as portable phones, smartphones, personal digital assistants (PDA), music players, and electronic tablets have been widespread in recent years. Some display devices of the mobile devices include those which perform scroll display of a display screen in accordance with user's touch operation performed on the display screen displayed at a display section.

Some display devices are loaded with a function called inertia scroll which, upon the scroll display of the display screen in accordance with swipe operation (operation of sliding a finger being in contact with the screen), gradually attenuates a scroll speed as if inertia is acting without ending the scroll display even immediately after separation of user's finger from the display screen.

Some display devices are loaded with a function of displaying a scroll bar indicating at which position in the whole of the display screen currently displayed at the display section is located while the scroll display is being performed. In addition, various inventions have been suggested which improve operability of the display device.

### SUMMARY

As one aspect of this disclosure, a technology obtained by further improving the aforementioned technology will be suggested.

A display device according to one aspect of this disclosure includes a display section and a control unit. The display section includes a touch panel function. The control unit includes a processor and performs, as a result of operation performed in accordance with an operation program by the processor, display control of the display section and control of receiving an instruction based on touch operation performed on the display section and detected by the touch panel function. The control unit performs, upon reception of an instruction for scrolling a display target image to be displayed at the display section based on the touch operation, scroll display of a display screen displayed at the display section, and calculates a display end position of the display target image provided by the scroll display based on the instruction for scrolling, and before ending of the scroll display, displays, at a predefined position in a display region of the display section, at least one portion of a final image to be displayed at the display end position.

A computer-readable non-transitory recording medium according to another aspect of this disclosure records a display control program causing a computer to function as a control section performing display control of a display section and control of receiving an instruction based on touch operation performed on the display section and detected by a touch panel function included in the display section. The display control program further causes the computer to function so that the control section performs, upon reception of an instruction for scrolling based on the touch operation, scroll display of a display screen displayed at the display section, and calculates a display end position of a display target image provided by the scroll display based on the instruction for scrolling, and before ending of the scroll display, displays, at a predefined position in a display region of the display section, at least one portion of a final image to be displayed at the display end position.

### BRIEF DESCRIPTION OF THE DRAWINGS

FIG. 1 is a plan view illustrating outer appearance of a display device according to one embodiment of this disclosure.

FIG. 2 is a functional block diagram schematically illustrating main inner configuration of the display device according to one embodiment of this disclosure.

FIG. 3 is a diagram illustrating one example of a received mail list image.

FIG. 4 is a diagram illustrating one example of a display screen displayed at a display section.

FIGS. 5A and 5B are diagrams illustrating one example of the display screen displayed at the display section where 5A illustrates a scroll bar and 5B illustrates a scroll bar display region.

FIG. 6 is a flowchart illustrating display processing performed by the display device according to one embodiment of this disclosure.

FIG. 7 is a flowchart illustrating the display processing performed by the display device according to one embodiment of this disclosure.

FIG. 8 is a diagram illustrating one example of a final image to be displayed in a display region of the display section as a display screen provided upon ending of scroll display.

FIG. 9 is a diagram illustrating one example of the display screen displayed at the display section, with a final part of a final image being displayed at the display section.

FIG. 10 is a diagram illustrating one example of the display screen displayed at the display section.

FIGS. 11A and 11B are diagrams illustrating one example of the display screen displayed at the display section where 11A illustrates a state provided upon swipe operation and 11B illustrates a state provided upon start of the scroll display.

FIGS. 12A and 12B are diagrams illustrating one example of the display screen displayed at the display section where 12A illustrates a state provided during the scroll display and 12B illustrates a state provided upon the ending of the scroll display.

### DETAILED DESCRIPTION

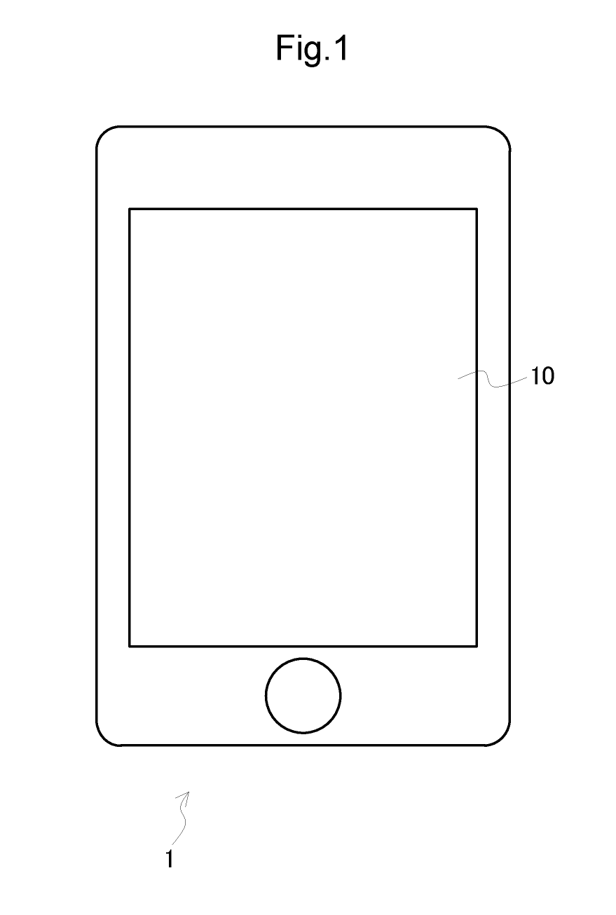

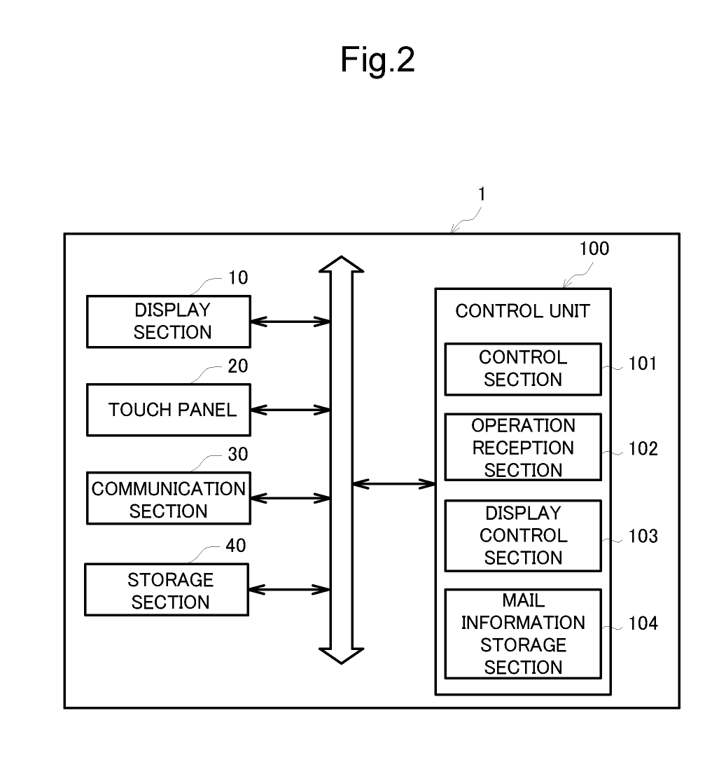

Hereinafter, a display device and a display control program according to one embodiment of this disclosure will be described with reference to the drawings. FIG. 1 is a plan view illustrating outer appearance of the display device according to one embodiment of this disclosure. FIG. 2 is a functional block diagram schematically illustrating main inner configuration of the display device according to one embodiment of this disclosure.

The display device 1 according to one embodiment of this disclosure is, for example, a mobile device such as a smartphone, and includes a display section 10, a touch panel 20, a communication section 30, a storage section 40, and a control unit 100. Each of the aforementioned structures are capable of data or signal transmission and reception therebetween via, for example, a central processing unit (CPU) bus.

The display section 10 is formed of, for example, a liquid crystal display (LCD) or an organic light-emitting diode (OLED). The display section 10 displays, for example, response and data results from the control unit 100.

The touch panel 20 is, for example, a so-called resistance film type or electrostatic capacitance type touch panel. The touch panel 20 is arranged on a front surface of the display section 10, and detects user's contact on a display screen displayed by the display section 10 together with a position of the aforementioned contact. Upon detection of the contact by the user, the touch panel 20 outputs a detection signal indicating a coordinate position of a point of the contact, for example, to an operation reception section 102, to be described later on, of the control unit 100. As described above, the touch panel 20 plays a role as an operation section to which user operation performed on the display screen displayed by the display section 10 is inputted.

Note that the touch panel 20 includes even a touch panel which detects, for example, user's finger upon approach of the figure to the display screen at a fixed distance without direct contact on the display screen. Thus, “contact” in this embodiment includes, as actual contact, even a state in which approach of, for example, a finger to the display screen at the aforementioned fixed distance without direct contact of the display screen is detected by a function of the touch panel 20.

The display device 1 may also include, in addition to the touch panel 20, physical keys as an operation section to which user operation is inputted. The physical keys include, for example, arrow keys, a Page Up key, a Page Down key, etc.

The communication section 30 is a communication interface which includes a communication module such as a local area network (LAN) chip, not illustrated. The display device 1 is connected to another electronic device such as a personal computer (PC) via the network and performs data transmission and reception to and from, for example, the PC connected by the communication section 30.

The storage section 40 is a storage device such as a nonvolatile memory.

The control unit 100 is composed of a processor, a random access memory (RAM), a read only memory (ROM), etc. The processor is, for example, a CPU, an MPU, or an ASIC. The control unit 100 functions as a control section 101, the operation reception section 102, a display control section 103, and a mail information storage section 104 as a result of execution of the display control program, which is stored in the storage section 40, by the processor. Note that, however, each of the structures of the control unit 100 may be formed by a hard circuit without depending on operation based on the display control program. Hereinafter, the same applies to each embodiment unless otherwise is specified.

The control section 101 is in charge of overall operation control of the display device 1. The control section 101 is connected to the display section 10, the touch panel 20, the communication section 30, the storage section 40, etc. and performs operation control of each of the connected structures and signal or data transmission and reception to and from each structure. For example, the control section 101 includes a mail function, and performs mail transmission and reception and stores transmitted mail information and received mail information into the mail information storage section 104.

The operation reception section 102 receives touch operation which is performed on the display section 10 and detected by the touch panel 20. Based on a detection signal outputted from the touch panel 20, the operation reception section 102 specifies contents of the touch operation performed by the user and outputs an instruction corresponding to the specified contents to the control section 101, the display control section 103, etc.

The touch operation performed on the touch panel 20 includes, for example, tap operation and slide operation (including flick operation and swipe operation). For example, upon user's finger contact on the touch panel 20 followed user's finger separation from a position of the contact, the touch panel 20 outputs a detection signal indicating the contact-detected position to the operation reception section 102. In response to the detection signal, the operation reception section 102 specifies that user operation inputted by the user is, for example, tap operation.

Moreover, upon movement of the finger being in contact with the touch panel 20, the touch panel 20 outputs, to the operation reception section 102, a detection signal indicating each movement position from an initial position where the contact is first detected to a final position where the contact is finally detected. In response to the detection signal, the operation reception section 102 specifies that the user operation inputted by the user is slide operation (flick operation or swipe operation).

The display control section 103 performs display control of the display section 10. For example, upon receiving, from the operation reception section 102, an instruction for displaying a received mail list as a display target image from the user, the display control section 103 reads out received mal information from the mail information storage section 104, generates a received mail list image indicating the read received mail information, and displays the received mail list image at the display section 10. Note that the received mail list image is one example of a list image in the scope of the claims.

Upon specification by the operation reception section 102 that the touch operation performed by the user is, for example, swipe operation, the display control section 103 performs, for example, scroll display (inertia scroll) in which a scroll speed is gradually decelerated in accordance with a direction and a speed of the swipe operation. The operation reception section 102 detects the direction of the swipe operation based on a moving direction of the finger in contact on the touch panel 20, and detects the speed of the swipe operation based on a moving distance of the finger per unit time. Note that a case where the swipe operation is received will be described below as an example, but this disclosure may refer to each control performed by the operation reception section 102 and the display control section 103 based on another touch operation such as flick operation.

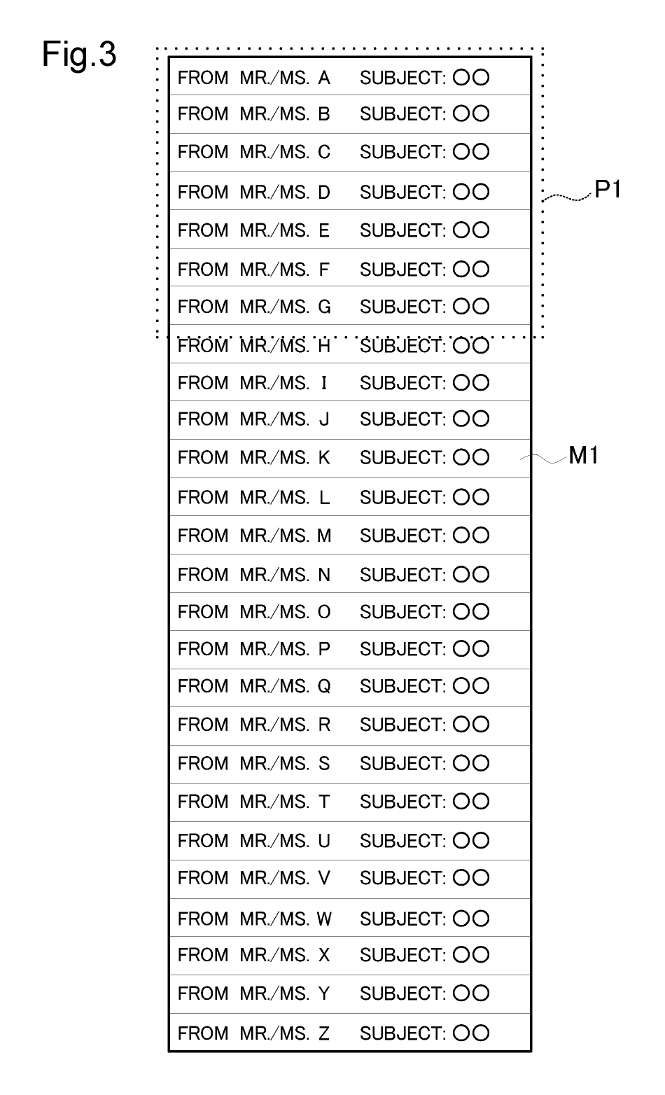

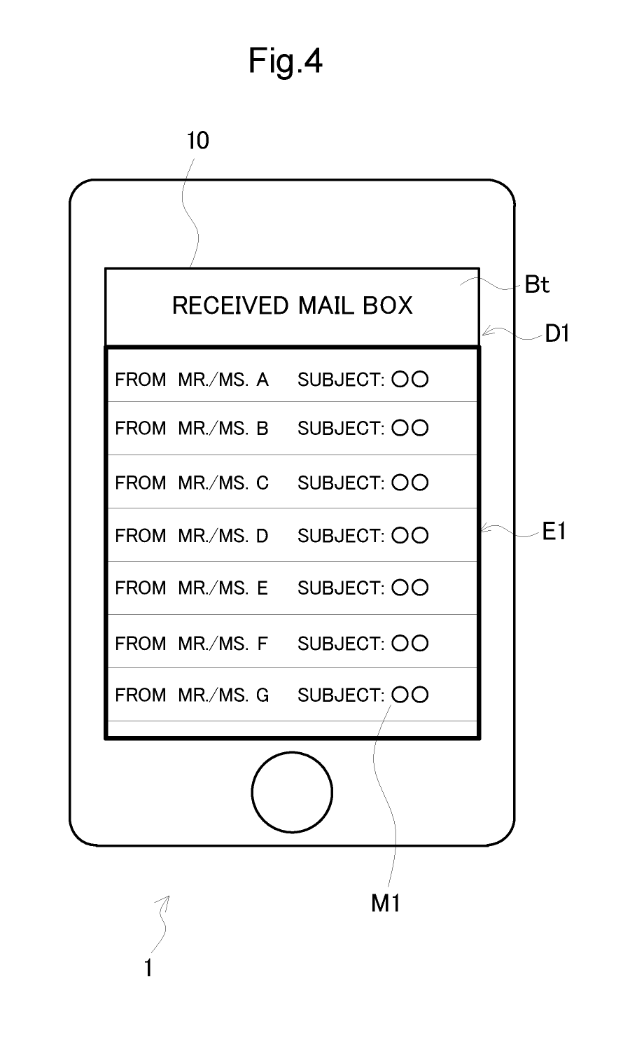

FIG. 3 is a diagram illustrating one example of the received mail list image, and FIG. 4 is a diagram illustrating one example of the display screen displayed at the display section 10.

Upon generation of received mail list image M1, in a case where the received mail information is large in quantity and the received mail list image M1 is not fit within a display region of the display section 10, the display control section 103 sequentially displays individual portions of the received mail list image M1 in a display region E1 through scroll display. A display target image to be displayed at the display section 10 by the display control section 103 as a display target to be scroll-displayed is referred to as a scroll image in this embodiment. Specifically, the scroll image is an image entire of which cannot be displayed in the display region of the display section 10 at one display trial and entire of which is not displayed in the display region unless individual portions of the image are sequentially displayed in the display region through scroll display. The received mail list image M1 in a case where the received mail information is large in quantity serves as one example of the scroll image. The display target image is one example of a display target list image in the scope of the claims.

The display control section 103 has a display screen D1 which is displayed at the display section 10 and which is composed of: a title bar Bt displaying, for example, a title name “Received Mail Box”; and a partial image of the received mail list image M1 arranged in the display region E1. The display region E1 will be described as a region other than a display portion of the title bar Bt on the screen of the display section 10 in this embodiment. What is displayed in the display region E1 illustrated in FIG. 4 is a portion P1 illustrated by a broken line in FIG. 3.

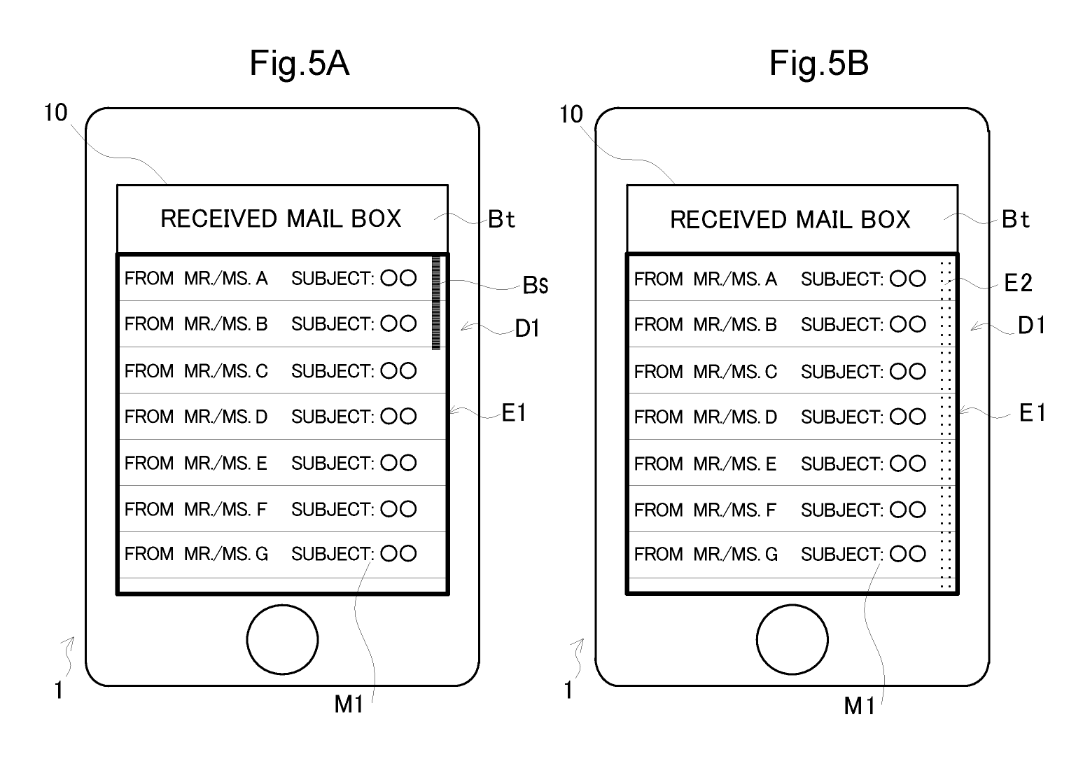

To scroll-display the received mail list image M1, as illustrated in FIG. 5A, the display control section 103 displays an image of a scroll bar Bs indicating, by a display position in the display region E1, which range in the entire received mail list image M1 (FIG. 3) is indicated by the portion P1 displayed in the display region E1.

A region indicated by a broken line in FIG. 5B is a scroll bar display region E2 indicating a displayable region of the scroll bar Bs. The display control section 103 does not display the scroll bar display region E2 but, for example, may display the scroll bar display region E2 over the entire display region E1 (the entire in a vertical region in FIG. 5B).

FIG. 5A illustrates an example in which the display control section 103 displays the scroll bar Bs in a manner such as to be extended from an upper end of the scroll bar display region E2 to a position to which a length from a top position of the scroll bar display region E2 is 30% with respect to a full length of the scroll bar display region E2. In this case, the scroll bar Bs indicates that the portion P1 displayed in the display region E1 is a region ranging from a top position of the received mail list image M1 to a position where a length therebetween is 30% with respect to a full length of the received mail list image M1. That is, the scroll bar Bs indicates, by a display position thereof in the display region E1, which range in the entire received mail list image M1 (FIG. 3) is indicated by the portion P1 displayed in the display region E1.

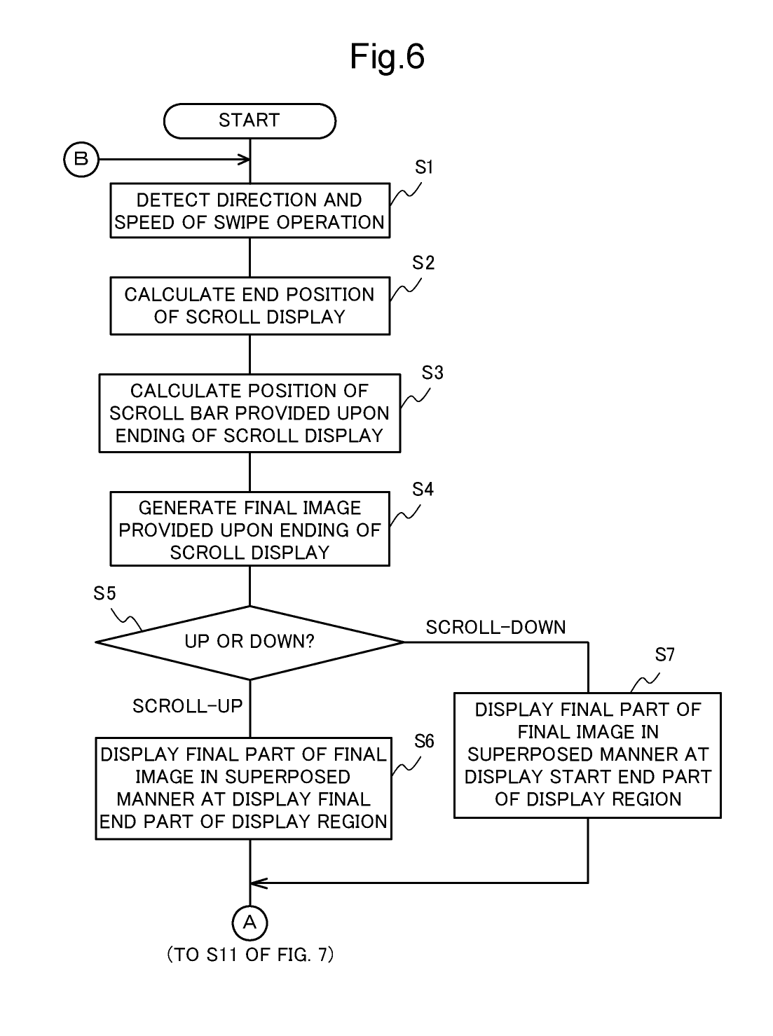

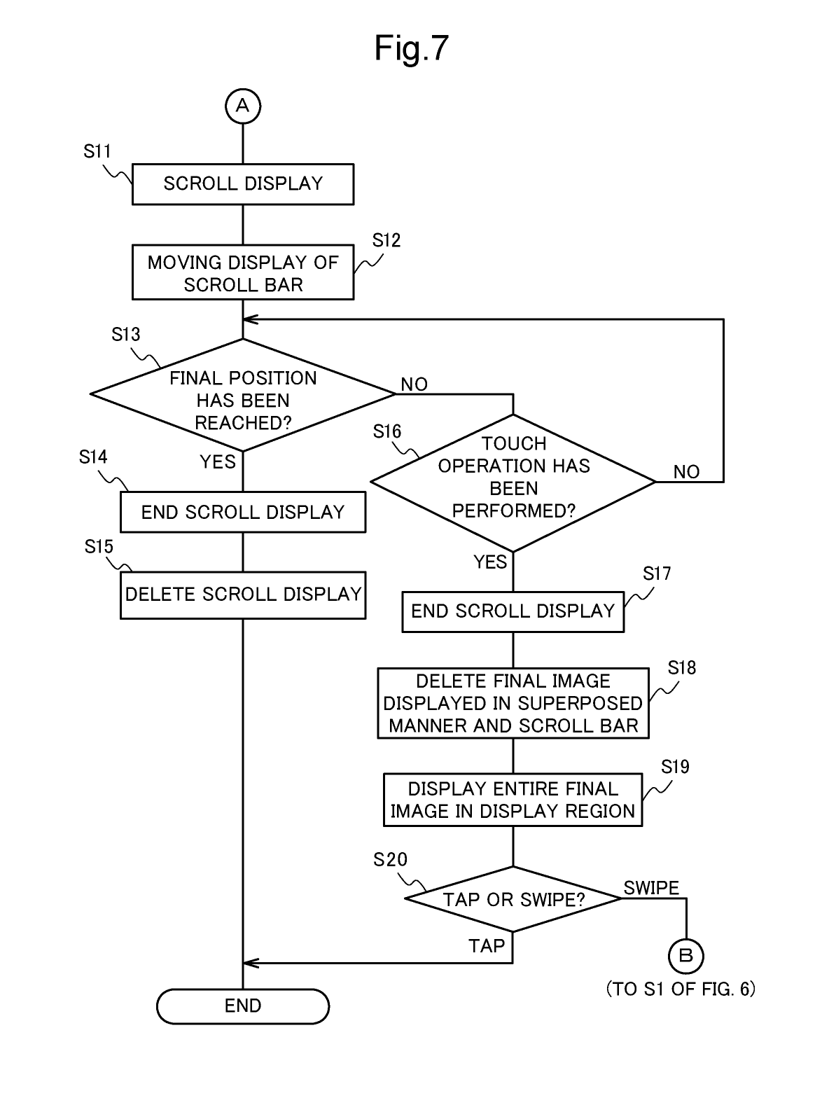

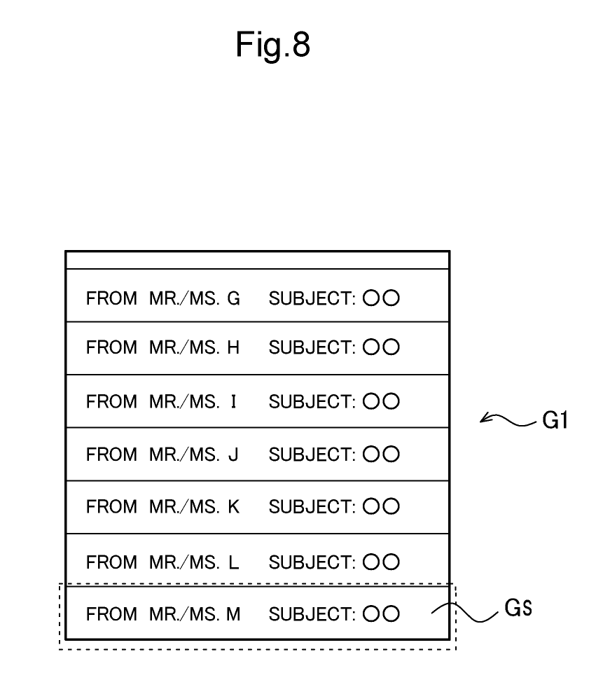

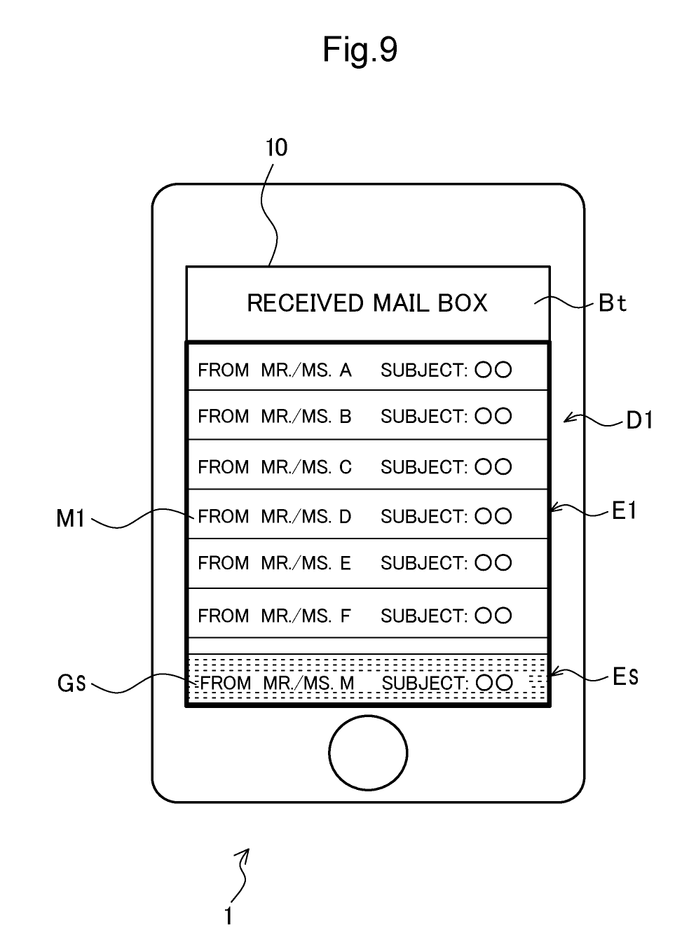

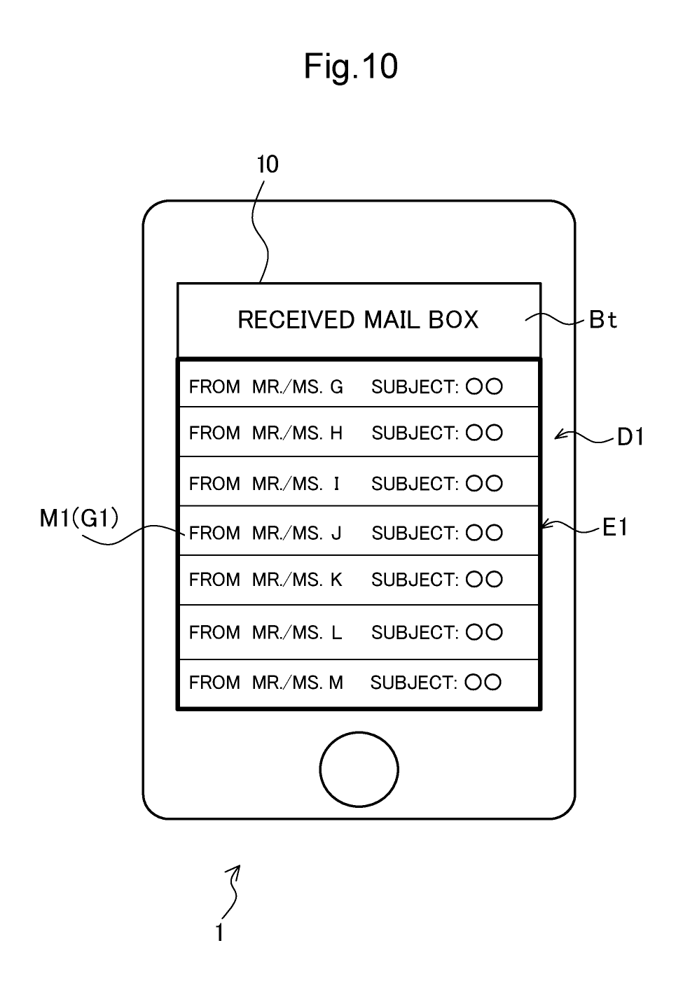

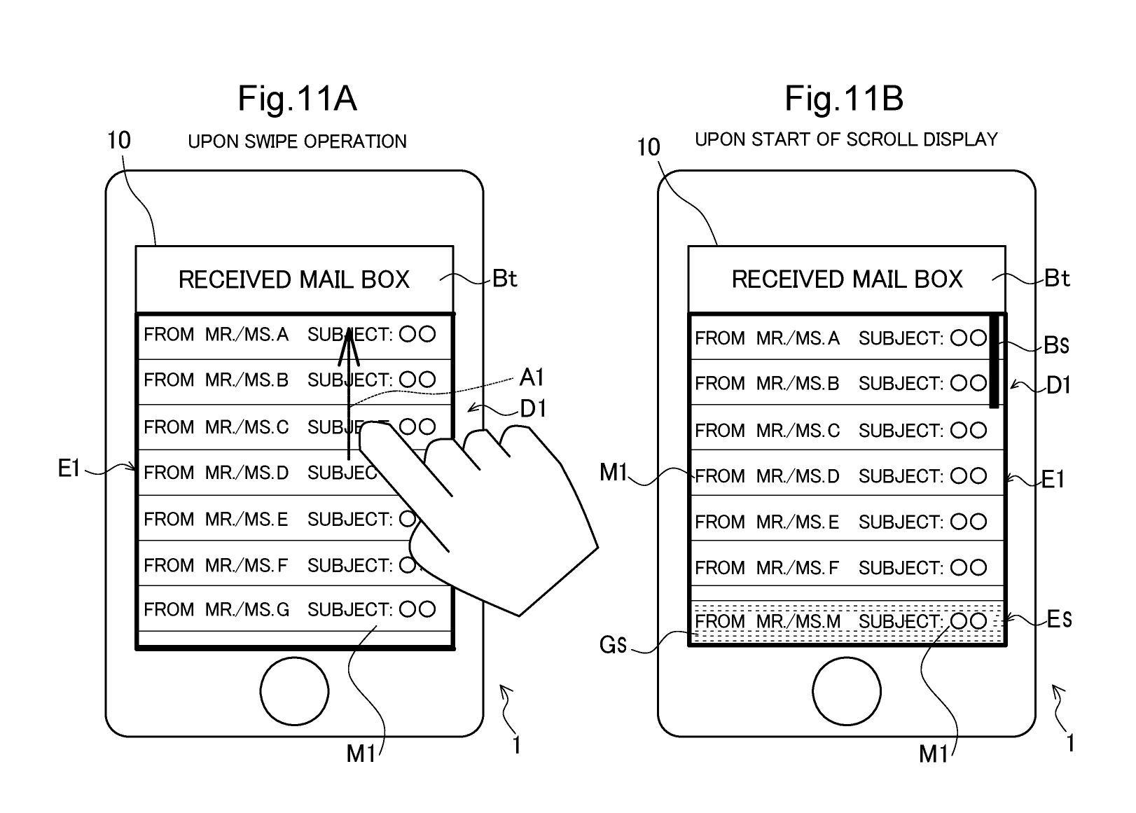

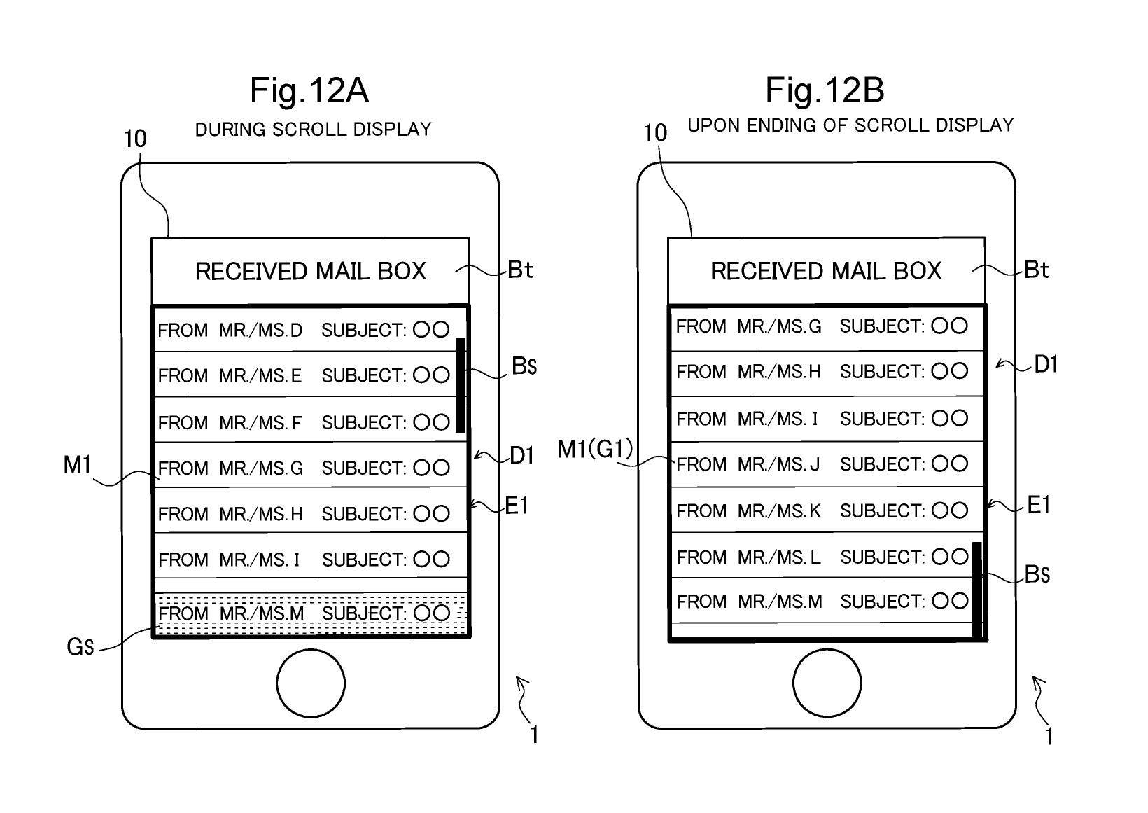

Next, display processing performed by the display device 1 will be described. FIGS. 6 and 7 are flowcharts illustrating the display processing performed by the display device 1. FIG. 8 is a diagram illustrating one example of a final image displayed in the display region E1 as a display screen provided upon ending of the scroll display. FIG. 9 is a diagram illustrating a state in which a final part of the final image is displayed at the display section 10 in a superposed manner. FIG. 10 is a diagram illustrating a state in which the final image is displayed at the display section 10. FIGS. 11A, 11B, 12A, and 12B each illustrate one example of the display screen displayed at the display section 10. FIG. 11A illustrates a state upon swipe operation, and FIG. 11B illustrates a display screen provided upon start of the scroll display. FIG. 12A illustrates a state during the scroll display, and FIG. 12B illustrates a state provided upon ending of the scroll display. Here, a description will be given referring to, as an example, a case where swipe operation is performed on the received mail list image M1 in a state (FIG. 4) in which the received mail list image M1 is displayed as a scroll image at the display section 10.

As illustrated in the example of FIG. 11A, for example, upon user's swipe operation performed on the received mail list image M1 in a direction of an arrow A1 (an upward direction in the figure) followed by detection of the swipe operation by the operation reception section 102, the operation reception section 102 receives a scroll instruction as an instruction based on the swipe operation and detects a direction and a speed of the swipe operation (S1). Based on the detected direction and speed of the swipe operation and based on a display position of the received mail list image M1 displayed at the display section 10 at this point, the operation reception section 102 calculates an amount of scroll performed on the received mail list image M1 and specifies a display end position for the scroll display on the received mail list image M1 (S2). The operation reception section 102 outputs the direction and speed of the swipe operation detected in S1, the display end position for the scroll display specified in S2, and the scroll instruction to the display control section 103.

Subsequently, based on the specified display end position, the display control section 103 calculates a position where the scroll bar Bs is to be displayed at the entire scroll bar display region E2 upon ending of the scroll display (the calculated position is also where the scroll bar Bs is to be displayed at the display region E1 upon the ending of the scroll display) (S3).

Further, based on the display end position calculated in S2, the display control section 103 generates at least one portion of a final image to be displayed in the display region E1 of the display section 10 as the display screen provided upon the ending of the scroll display (S4). In this embodiment, a portion of the final image finally displayed in the display region E1 upon the scroll display, that is, the final part of the final image is provided as one portion described above. A portion indicated by a broken line in FIG. 8 represents a final part Gs of a final image G1 upon, for example, scroll-up. Illustrated here is an example in which mail information from “Mr/Ms. G” as a mail transmitter to “Mr/Ms. M” is illustrated on the final image G1. The final part Gs is an image portion illustrating the mail information “Mr./Ms. M”. Note that the final image G1 is one example of a final list image in the scope of the claims.

Subsequently, based on the detected direction of the swipe operation, the display control section 103 determines whether or not the scroll instruction is for scroll-up or scroll-down (S5). For example, in a case where the direction of the swipe operation is an upward direction with respect to the display section 10 in FIG. 9, the display control section 103 determines that the scroll display is for scroll-up for displaying a portion hidden on a lower side of the display section 10. On the contrary, in a case where the direction of the swipe operation is a downward direction with respect to the display section 10 in FIG. 9, the display control section 103 determines that the scroll display is for scroll-down for displaying a portion hidden on an upper side of the display section 10.

Here, upon determination that the scroll instruction is for scroll-up (scroll-up in S5), the display control section 103 displays an image of the final part Gs (FIG. 8) at a position of a predefined display region Es (FIG. 9) in the display region E1 displaying the received mail list image M1 in a superposed manner on the displayed received mail list image M1 (S6).

On the other hand, upon determination that the scroll display is for scroll-down (scroll-down in S5), the display control section 103 displays an image, serving as a final part of a final image provided upon the scroll-down, at a position of a display start end part in the display region E1 displaying the received mail list image M1 in a superposed manner on the received mail list image M1 (S7). Note that in both cases of the scroll-up and the scroll-down, it is preferable that the display control section 103 display the image of the final part in a display manner different from a display manner of other image portions displayed in the display region E1 (see FIGS. 11B and 12A). As described above, it is possible to display the image of the final part in the display manner different from the display manner of the other image portions to thereby stress the image of the final part for the user, permitting the user to easily view the image of the final part.

Subsequently, the display control section 103 performs scroll display (for example, inertia scroll) through scroll-up or scroll-down which gradually decelerate a scroll speed on the received mail list image M1 in accordance with the direction and speed of the swipe operation detected in S1 and results obtained in S5 (S11).

The display control section 103 displays the scroll bar Bs in the display region E1 upon the aforementioned scroll display. For example, as illustrated in FIG. 11B, the display control section 103 displays the scroll bar Bs at a position in the display region E1 corresponding to a position of the image displayed in the display region E1 in the entire received mail list image M1 (FIG. 3) displayed at the display section 10 (a position in the entire scroll bar display region E2).

Here, for example, in a case where the scroll display indicated by the scroll instruction is for scroll-up, the display control section 103 displays the scroll bar Bs at the upper end of the scroll bar display region E2 upon start of the scroll display. FIG. 11B illustrates this case.

In a case where the scroll display indicated by the scroll instruction is for scroll-down, the display control section 103 displays the scroll bar Bs at a lower end of the scroll bar display region E2 upon the start of the scroll display.

Note that the scroll bar display region E2 serves as a moving display range of the scroll bar Bs upon the scroll display in the both cases.

Then the display control section 103 moves the display position of the scroll bar Bs in accordance with a screen variation in the display region E1 by the scroll display (S12). In this case, the display control section 103 varies the display position of the scroll bar Bs in the scroll bar display region E2 in accordance with a portion of the received mail list image M1 corresponding to the portion P1 as the image displayed in the display region E1, as illustrated in the example of scroll-up in FIG. 12A.

The display control section 103 performs the scroll display and moving display of the scroll bar Bs until the portion P1 displayed in the display region E1 reaches the display end position (NO in S13), and without reception of the touch operation performed on the final part Gs displayed in a superposed manner in the display region E1 by the operation reception section 102 (NO in S16), the display control section 103 ends the scroll display of the received mail list image M1 (S14) upon reach of the portion P1 displayed in the display region E1 at the display end position (YES in S13), as illustrated in the example upon the scroll-up in FIG. 12B. The display control section 103 deletes the scroll bar Bs from the display section 10 (S15). Specifically, the display control section 103 displays the final image G1 in the display region E1. At this point, the final part Gs which has been displayed in a superposed manner in the display region E1 corresponds to an image portion displayed at the display final end part or the display start end part at a point in time at which the portion P1 displayed in the display region E1 reaches the display end position. In a case where the image of the final part Gs is displayed in the display manner different from the display manner of the other image portions displayed in the display region E1, the display control section 103 displays the image of the final part Gs in the same manner as the display manner of the other image portions displayed in the display region E1.

On the other hand, in a case where touch operation performed on the final part Gs is received by the operation reception section 102 (YES in S16) when the received mail list image M1 has not yet reached the end position during the scroll display and the moving display of the scroll bar Bs (NO in S13), the display control section 103 ends the scroll display (S17), no longer displays the final part Gs and the scroll bar Bs which have been displayed in the display region E1 (S18), and immediately stops the scroll display to instantly display, in the display region E1, the entire final image G1 generated in S4 (S19). No longer displaying the scroll bar Bs from the example illustrated in FIG. 12B provides one example of the display provided by S19.

Subsequently, the display control section 103 determines whether the touch operation received by the operation reception section 102 is tap operation or swipe operation (S20), and upon determination that the touch operation is tap operation (Tap in S20), ends the display processing. On the other hand, upon determination that the touch operation is swipe operation (Swipe in S20), the display control section 103 returns to S1 (FIG. 6) to start processing for new scroll display.

Now, the display screen displayed at the display section 10 upon the scroll display processing will be described again. Upon swipe operation performed in the direction of the arrow A1 as illustrated in FIG. 11A, as illustrated in FIG. 11B, one portion of the final image G1 (the final part Gs of the final image G1 here) to be displayed as the display screen upon the ending of the scroll display is displayed in the predefined display region Es (the display final end part upon the scroll-up and the display start end part upon scroll-down here) of the display region E1, and the scroll bar Bs indicating a display range with respect the entire received mail list image M1 (FIG. 3) displayed at the display section 10 is displayed at the upper end of the display region E1.

Then, as illustrated in FIG. 12A, moving display of the scroll bar Bs is provided in conjunction with the scroll display of the received mail list image M1 during the scroll display, and as illustrated in FIG. 12B, the received mail list image M1 corresponding to the entire final image G1 is displayed in the display region E1.

Here, avoiding the ending of the scroll display immediately after finger separation from the display screen in the typical display device as is the case with inertia scroll has an advantage that loads on the user operation can be reduced while having a disadvantage that it is difficult to recognize a scroll display end position. Moreover, neither disclosure nor implication is provided for a technology of previously notifying the user of the end position in the whole where the scroll display ends in the typical display devices.

On the contrary, with this embodiment, the final part Gs as one portion of the final image G1 to be displayed as the display screen provided upon the ending of the scroll display is displayed in the predefined display region Es of the display section 10 before the ending of the scroll display, thus making it possible to reliably and previously notify the user of the image displayed at the position where the scroll display ends even upon continuation of the scroll display immediately after the swipe operation.

Upon touch operation performed on the final part Gs of the final image G1 displayed at the display section 10, the entire final image G1 is immediately displayed in the display region E1 of the display section 10, thus resulting in no need of user's waiting for the ending of the scroll display in order to view the final image G1, which permits time shortening.

This disclosure is not limited to configuration of the embodiment described above and various modifications thereof are also permitted. This embodiment has been described referring to a smartphone as one embodiment of the display device according to this disclosure, but the smartphone is just one example, and any of other electronic devices, for example, a portable phone, a PDA, a music player, and an electronic tablet may be used.

The configuration and the processing indicated by the aforementioned embodiment with reference to FIGS. 1 to 12 are just one embodiment of this disclosure, and are not intended in any way to limit this disclosure.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. A display device comprising:
a display section including a touch panel function; and
a control unit including a processor and performing, as a result of operation performed in accordance with an operation program by the processor, display control of the display section and control of receiving an instruction based on touch operation performed on the display section and detected by the touch panel function, wherein
the control unit performs, upon reception of an instruction for scrolling a display target image to be displayed at the display section based on the touch operation, scroll display of a display screen displayed at the display section,
calculates a display end position of the display target image provided by the scroll display based on the instruction for scrolling, and
before ending of the scroll display, displays, at a predefined position in a display region of the display section, at least one portion of a final image to be displayed at the display end position.

2. The display device according to claim 1, wherein
the predefined position is a display final end part in the display region.

3. The display device according to claim 1, wherein
the control unit displays, in the display region, a scroll bar indicating, by a display position in the display region, which range in an entire display target image targeted for the scroll display is indicated by the display screen displayed at the display section.

4. The display device according to claim 1, wherein
upon reception of touch operation performed on the one portion of the final image during the scroll display, the control unit ends the scroll display and displays an image indicating the entire final image at the display section.

5. The display device according to claim 1, wherein
the control unit
in a case where the scroll display is for scroll-up, displays, as the one portion of the final image at a display final end part as the predefined position in the display region, a final part upon display of the final image, and
in a case where the scroll display is for scroll-down, displays, as the one portion of the final image at a display start end part as the predefined position in the display region, the final part upon the display of the final image.

6. The display device according to claim 5, wherein
the control unit displays an image of the final part at the display section in the display region in a display manner different from a display manner of another image portion displayed in the display region.

7. The display device according to claim 1, wherein
the control unit
displays a list image as the display target image, and upon reception of an instruction for scrolling the list image based on the touch operation, performs the scroll display of the display screen displayed at the display section, and
where the instruction for scrolling is for slide operation, calculates a display end position of the list image by the scroll display based on a direction and a speed of the slide operation, and before ending of the scroll display, displays at least the one portion of the final list image, to be displayed at the display end position, in a superposed manner at a predefined position in a display region of the list image.

8. The display device according to claim 7, wherein
the predefined position is a display final end part in the display region of the list image.

9. The display device according to claim 7, wherein
the control unit displays, in the display region, a scroll bar indicating, by a display position in the display region, which range in the entire display target list image targeted for the scroll display is indicated by the list image displayed at the display section.

10. The display device according to claim 7, wherein
upon reception of touch operation performed on the one portion of the final list images during the scroll display, the control unit ends the scroll display and displays an image indicating the entire final list image at the display section.

11. The display device according to claim 7, wherein
the control unit,
in a case where the scroll display is for scroll-up, displays, as the one portion of the final list image at a display final end part as the predefined position in the display region, a final part upon display of the final image, and
in a case where the scroll display is for scroll-down, displays, as the one portion of the final list image at a display start end part as the predefined position in the display region, the final part upon the display of the final image.

12. The display device according to claim 11, wherein
the control unit displays an image of the final part at the display section in the display region in a display manner different from a display manner of another image portion displayed in the display region.

13. A computer-readable non-transitory recording medium recording a display control program,
causing a computer to function as a control section
performing display control of a display section and control of receiving an instruction based on touch operation performed on the display section and detected by a touch panel function included in the display section, and
further causing the computer to function so that the control section,
upon reception of an instruction for scrolling based on the touch operation, performs scroll display of a display screen displayed at the display section, and
calculates a display end position of a display target image provided by the scroll display based on the instruction for scrolling, and before ending of the scroll display, displays, at a predefined position in a display region of the display section, at least one portion of a final image to be displayed at the display end position.
